(19) United States
(12) Patent Application Publication
(10) Pub. No.: US 2002/0143936 A1
(43) Pub. Date: Oct. 3, 2002

(54) Management device, method and recording medium for managing network device

(76) Inventor: Kazutoshi Yu, Kobe-Shi (JP)

Correspondence Address: Platon N. Mandros, BURNS, DOANE, SWECKER & MATHIS, L.L.P., P.O. Box 1404, Alexandria, VA, 22313-1404, US

(21) Appl. No.: 10/097,270

(22) Filed: Mar. 15, 2002

(30) Foreign Application Priority Data
Mar. 28, 2001 (JP) 2001-93441

(51) Int. Cl. G06F 15/173; G09G 5/00

(52) U.S. Cl. 709/224; 345/736

(57) ABSTRACT

A management device detects the existence of a copying machine connected to a LAN (S2); determines whether the detected copying machine is capable of creating a link (S4); and transmits link information to the detected copying machine if the copying machine is determined to be capable of creating a link (S5).

This application is based on application No. 2001-093441 filed in Japan, the content of which is hereby incorporated by reference.

### BACKGROUND OF THE INVENTION

1. Field of the Invention

The present invention relates to a management device, a network management program, a computer readable recording medium having the network management program recorded thereon, a managed device, a link creating program, and a computer readable recording medium having the link creating program recorded thereon, and more particularly to a management device for creating a link between the management device and a managed device connected to a network, a network management program, a computer readable recording medium having the network management program recorded thereon, a managed device, a link creating program, and a computer readable recording medium having the link creating program recorded thereon.

2. Description of the Related Art

It is known to construct a system that allows the use of image forming apparatuses such as copying machines, printers, etc. by connecting them to a local area network or the like. In such a system, a personal computer for management (hereinafter called the “management device”) is provided in order to manage the plurality of printers and copying machines. The management device queries the plurality of printers and copying machines on the network at predetermined intervals of time to keep track of the current states of the printers and copying machines in real time. The management device for managing the plurality of printers and copying machines gathers the states of the printers and copying machines at predetermined intervals of time by transmitting management information called MIB (Management Information Base) between the management device and the plurality of managed printers and copying machines by using a protocol called SNMP (Simple Network Management Protocol). Each copying machine or printer is identified by its associated domain name or network address such as an IP (Internet Protocol) address or mail address, which is stored in the management device by being associated with information identifying the printer or copying machine, for example, its model name and serial number.

Based on the gathered management information, the management device that manages the printers and copying machines produces a display showing the current state of the copying machine or printer identified by the network address or domain name. The user of the management device can thus keep track of the current states of the plurality of printers and copying machines on the network in real time.

However, when there is another personal computer or device connected to the network, and the printer or copying machine that it uses to produce an output is prespecified, that other personal computer or device cannot recognize the existence of printers or copying machines other than the prespecified printer or copying machine. Therefore, when the user of such a personal computer desires to produce the output on some other printer or copying machine connected to the network, the user has to acquire the network address of the printer or the copying machine from the network administrator or the like and register the new output printer or copying machine with his or her personal computer.

While the user of the personal computer can acquire information on other printers or copying machines connected to the network by accessing the management device that manages the printers and copying machines, the user cannot access the management device unless the user knows the network address of the management device.

### SUMMARY OF THE INVENTION

The present invention has been devised to solve the above problems, and an object of the invention is to provide a management device that can link a device connected to a network, such as a printer or a copying machine, to the management device that manages the printers and copying machines, and also provide a network management program to be executed on the management device, and a computer readable recording medium having the network management program recorded thereon.

Another object of the invention is to provide a managed device that can easily create a link to the management device, a link creating program to be executed on the managed device, and a computer readable recording medium having the link creating program recorded thereon.

To achieve the above objects, according to an aspect of the present invention, a management device for managing a device through a network, comprises: a detecting portion for detecting an existence of the device connected to the network; a determining portion for determining whether the detected device is capable of creating a link; and a transmitting portion for transmitting to the detected device link information for linking to the management device when the detected device is determined to be capable of creating a link.

According to the structure, when the existence of a device connected to the network is detected, it is determined whether the detected device is capable of creating a link, and when the detected device is determined to be capable of creating a link, link information for linking to the management device is transmitted to the detected device. In this way, the link information for linking to the management device is transmitted to any device that is connected to the network and that is determined to be capable of creating a link. The invention can thus provide a management device that can link a device connected to a network to the management device.

According to another aspect of the present invention, a managed device comprises: a receiving portion for receiving, from a management device through a network, link information for linking to the management device; and link creating portion for creating a link to the management device based on the received link information.

According to another aspect of the present invention, a managed device managed by a management device connected to a network, comprises: an acquiring portion for acquiring a network address of the management device from the management device; a detecting portion for detecting whether the management device is capable of creating a link to the managed device; and a link creating portion for creating a link to the management device based on the acquired network address when it is detected by the detecting portion that the management device is capable of creating a link to the managed device.

### BRIEF DESCRIPTION OF THE DRAWINGS

These and other objects and features of this invention will become clear from the following description, taken in conjunction with the preferred embodiments with reference to the accompanied drawings in which:

FIG. 1 is a diagram showing in schematic form a device management system according to one embodiment of the present invention;

FIG. 2 is a block diagram showing in simplified form the configuration of a management device in the device management system of the present embodiment;

FIG. 3 is a block diagram showing in simplified form the configuration of a copying machine in the device management system of the present embodiment;

FIG. 4 is a flow chart showing the flow of a network management process performed in the management device of the present embodiment;

FIG. 5 is a diagram showing one example of a Web page stored in the management device of the present embodiment;

FIG. 6 is a flow chart showing the flow of a link creating process (1) performed in the copying machine of the present embodiment; and

FIG. 7 is a flow chart showing the flow of a modified example of the link creating process performed in the copying machine of the present embodiment.

### DETAILED DESCRIPTION OF THE PREFERRED EMBODIMENTS

An embodiment of the present invention will be described below with reference to the accompanying drawings. Throughout the drawings, the same reference characters designate the same or corresponding components, and their descriptions, once given, will not be repeated.

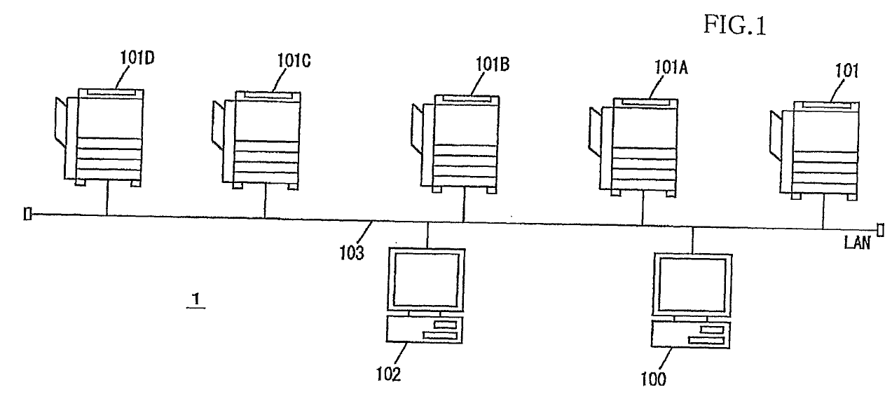

FIG. 1 is a diagram showing in schematic form a device management system according to one embodiment of the present invention. In FIG. 1, the device management system 1 includes a management device 100 and a plurality of copying machines 101, 101A, 101B, 101C, and 101D as managed devices.

The management device 100 and the copying machines 101, 101A, 101B, 101C, and 101D are connected to a local area network (LAN) 103. The management device 100 communicates with the copying machines 101, 101A, 101B, 101C, and 101D via the LAN 103. The states of the copying machines 101, 101A, 101B, 101C, and 101D are gathered at predetermined intervals of time. The states of the respective copying machines 101, 101A, 101B, 101C, and 101D are displayed on a display attached to the management device 100.

The state of a copying machine indicates, for example, whether the copying machine is in an operating state or a stopped state or in other state such as a standby state. When the copying machine stops because of a trouble such as paper jam or empty toner, information indicating the cause for the stoppage is included in the stopped state information. The copying machine state information further includes information indicating the remaining amounts of consumables such as paper and toner.

The management device 100 communicates with the plurality of copying machines 101, 101A, 101B, 101C, and 101D by using the SNMP protocol, and gathers the states of the plurality of copying machines 101, 110A, 101B, 101C, and 101D at predetermined intervals of time by reading MB from the respective copying machines.

In the present embodiment, the devices to be managed have been described as being copying machines, but they may include other devices that can be connected to the LAN 103, such as facsimile machines, printers, image readers, copying machines combined with any of such devices, personal computers, communication devices, and storage devices.

Further, in the present embodiment, the five copying machines 101, 101A, 101B, 101C, and 110D have been shown as the managed devices, but the number of managed devices is not limited to five. It will be noted here that in the present embodiment, the processing performed in any of the copying machines 101, 110A, 101B, 101C, and 110D is the same. The following description is given by taking the copying machine 101 as an example, unless specifically stated otherwise.

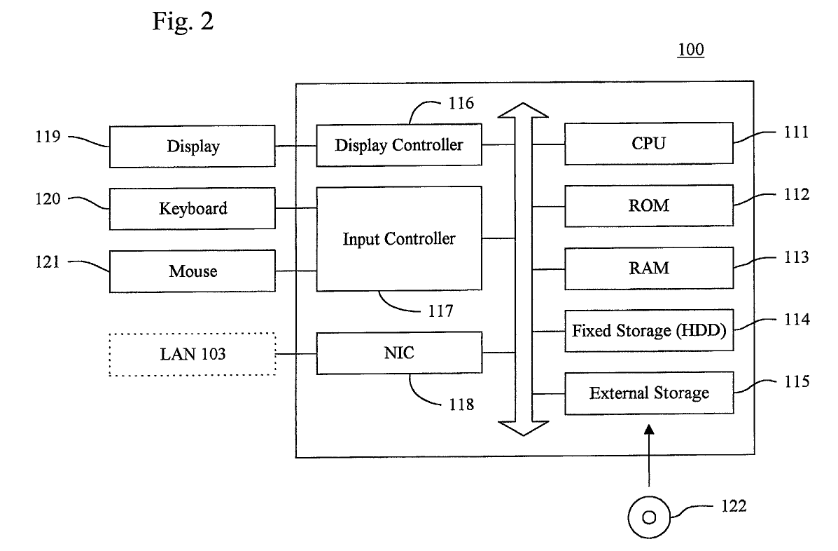

FIG. 2 is a block diagram showing in simplified form the configuration of the management device 100 in the device management system 1 of the present embodiment. The management device 100 is constructed from a personal computer or the like. As shown in FIG. 2, the management device 100 includes a central processing unit (CPU) 111 for controlling the entire operation of the management device 100, a read only memory (ROM) 112 for storing a program to be executed by the CPU 111, a random access memory (RAM) 113 as a working memory that the CPU 111 uses when executing the program, a fixed storage device 114 such as a magnetic disk drive, an external storage device 115, a display controller 116, an input controller 117, and a network interface card (NIC) 118 for connecting the management device 100 to the LAN 103.

The fixed storage device 114 is a magnetic disk drive such as a hard disk drive. The fixed storage device 114 stores programs to be executed by the CPU 111 as well as information necessary. The fixed storage device 114 also stores information concerning the copying machines to be managed by the management device 100. Information concerning a copying machine includes the model name, serial number, and the IP (Internet Protocol) address assigned to the copying machine.

The external storage device 115 reads a program and/or data recorded on a computer readable recording medium 122, and transfers them to the CPU 111. The external storage device 115 also writes necessary data to the computer readable recording medium 122 under instruction from the CPU 111 .

The computer readable recording medium 122 is a medium for holding a program in a fixed manner, for example, a tape medium such as a magnetic tape or a cassette tape, a disk medium such as a magnetic disk (flexible disk, hard disk, etc.) or an optical disk (CD-ROM, MO, MD, DVD, etc.), a card medium such as an IC card (including a memory card) or an optical card, or a semiconductor memory such as a mask ROM, EPROM, or flash memory. The recording medium 122 may also be configured as a recording medium for holding a program as necessary, for example, by downloading the necessary program from a network.

The display controller 116 is connected to the display 119 and displays information such as characters or graphics on the display 119 under instruction from the CPU 111. The input controller 117 is connected to a keyboard 120 and a mouse 121. Information entered from the keyboard 120 or the mouse 121 is transferred to the CPU 111.

The network interface card 118 connects the management device 100 to the LAN 103. The management device 100 can thus communicate with the plurality of copying machines 101, 110A, 101B, 101C, and 110D via the LAN 103.

The management device 100 can act as a Web server by executing a Web server program installed on the fixed storage device 114. A Web page written in HTML (HyperText Markup Language) is stored on the fixed storage device 114. At the management device 100 acting as a Web server, when an HTTP request message is received that is sent out using the HTTP protocol from an Web browser program running on a client computer 102 connected to the LAN 103, the Web page stored on the fixed storage device 114 is read out, and the readout Web page is transmitted to the client computer 102 that originated the HTTP request message. The client computer 102 that received the Web page can display the received Web page on its display by activating browser software.

The Web page stored on the fixed storage device 114 is identified by a URL (Uniform Resource Locator) which specifies its location on the network. If the Web page (HTML file) stored on the fixed storage device 114 is not specified by the URL specified in the received HTTP request message, the management device 100 reads out the top Web page stored on the fixed storage device 114, and transmits the readout top Web page to the client that originated the HTTP request message. The top Web page is preset by the Web server program installed on the management device 100.

The Web page stored on the fixed storage device 114 can carry URLs specifying the network addresses of the respective copying machines 101, 101A, 101B, 101C, and 101D connected to the LAN 103 or can include links to the respective copying machines. When a URL is carried on the Web page, a link to the resource specified by the URL is provided at the management device 100.

When a link is carried on the Web page, the link to the destination is created using a so-called tag.

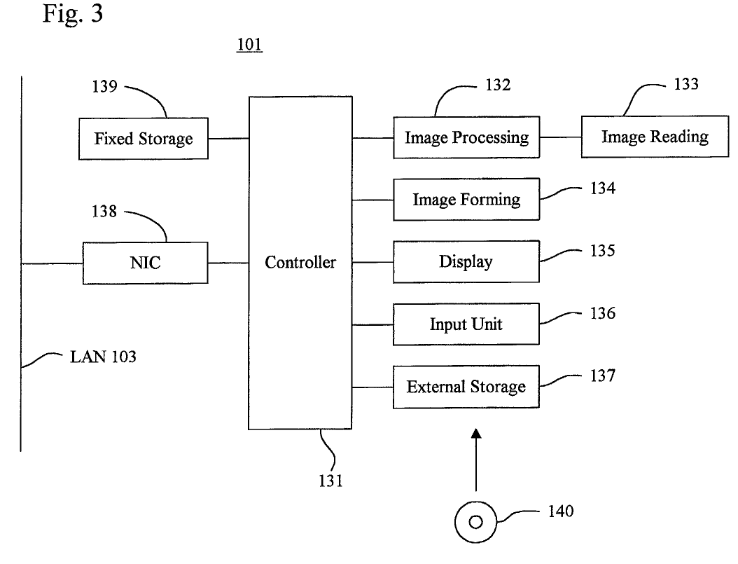

FIG. 3 is a block diagram showing in simplified form the configuration of the copying machine as a managed device in the device management system of the present embodiment. As shown in FIG. 3, the copying machine 101 includes a control section 131 for controlling the entire operation of the copying machine 101, a reading section 133 for reading a document image, an image processing section 132 for processing image data thus read, an image forming section 134 for forming an image on a recording medium such as paper on the basis of the processed image data, a display 135 for displaying necessary information, an input section 136 for inputting a necessary command to the copying machine 101, a network interface card (NIC) 138 for connecting the copying machine 101 to the LAN 103, a fixed storage device 139 for storing a Web page file and a Web server program, and an external storage device 137.

The control section 131 includes a central processing unit (CPU) for executing a program as a computer, a ROM for storing the program to be executed by the CPU, and a RAM used as a necessary memory area when the CPU executes the program.

The reading section 133 shines light on the document to be read, and receives reflected light by using a photoelectric conversion element such as a charge coupled device (CCD). The received light is converted into an electrical signal which is transferred as image data to the image processing section 132.

The image processing section 132 performs necessary image processing on the image data received from the image reading section 133 or transferred from a personal computer or the like via the LAN 103 and the NIC 138. The image data processed by the image processing section 132 is transferred to the image forming section 134.

The image forming section 134 forms an image on a recording medium such as paper by using the image data received from the image processing section 132.

The fixed storage device 139 stores a created Web page file. The Web page is created in advance, and can include therein link information for linking to the management device 100 connected to the LAN 103. This will be described later.

The display 135 displays the Web page stored on the fixed storage device 139. The display 135 can be constructed from a liquid crystal display, a cathode ray tube (CRT), or the like. The display 135 also display a menu screen for setting the mode of the copying machine 101, the current operation mode setting of the copying machine 101, etc.

The input section 136 is constructed from a numeric key pad, a touch panel, or the like, and used to enter a necessary command to the copying machine 101.

The NIC 138 is an interface for connecting the copying machine 101 to the LAN 103. The copying machine 101 can communicate with the management device 100 via the NIC 138.

The external storage device 137 reads a program and/or data recorded on a computer readable recording medium 140, and transfers them to the control section 131. The external storage device 137 also writes necessary data to the computer readable recording medium 140 under instruction from the control section 131. The computer readable recording medium 140 is similar to the previously described recording medium 122.

The copying machine 101 can act as a Web server. When the copying machine 101 acts as a Web server, a Web page file is stored on the fixed storage device 139. Then, when a connection to the copying machine 101 is established using the HTTP protocol from the management device 100, the client personal computer 102, or some other device connected to the LAN 103, and an HTTP request message is received from the client, the Web page stored on the fixed storage device 139 is read out, and the readout Web page is transmitted to the management device 100 or the client personal computer 102 that originated the HTT? request message.

The URL of the management device 100 can be included in the Web page stored on the fixed storage device 139. When the URL of the management device 100 is included in the Web page stored on the fixed storage device 139, a link to the management device 100 is provided on the Web page of the copying machine 101.

When the Web page read from the fixed storage device 139 is received at the client personal computer 102 connected to the LAN 103, then by specifying the URL of the management device 100 or clicking on the link carried on the received Web page, the Web page stored on the fixed storage device 114 in the management device 100 is transmitted from the management device 100 to the client personal computer 102. Accordingly, when a link to the management device 100 is set on the Web page stored in the copying machine, the client personal computer 102 can obtain the URL of the management device 100 from the Web page of the copying machine 101.

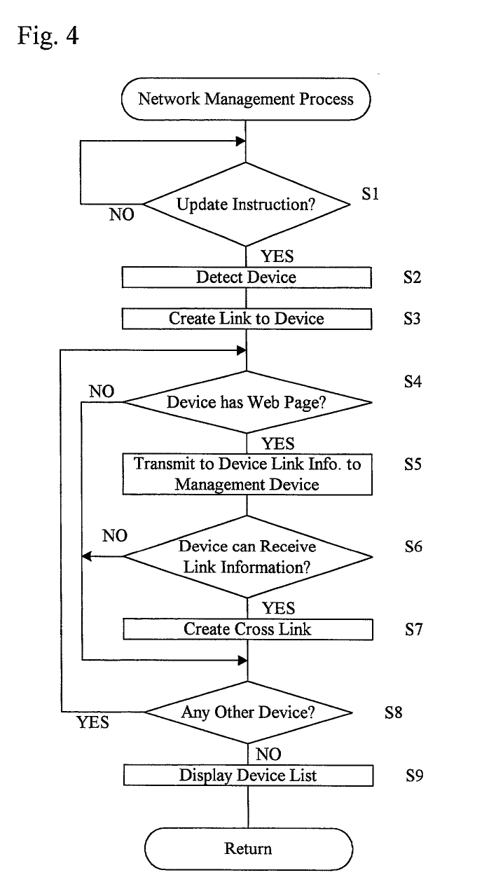

FIG. 4 is a flow chart showing the flow of the network management process performed in the management device 100 of the present embodiment. In the network management process of FIG. 4, first it is determined whether an update instruction has occurred (step S1). The update instruction is an instruction for rescanning the copying machines to be managed and identifying a new copying machine to be managed, if any. The update instruction occurs, for example, when the management device 100 is started up or a command indicating the update instruction is entered by the user of the management device 100 using the keyboard 120 or the mouse 121, or when a predetermined time has elapsed.

In the configuration in which the update instruction occurs at start up, the update instruction is made to occur only once at start up. In the configuration in which the update instruction occurs when a command indicating the update instruction is entered by the user of the management device 100, the update instruction is made to occur at the moment that the command is entered. In the configuration in which the update instruction occurs when a predetermined time has elapsed, the update instruction is made to occur at predetermined intervals of time during the execution of the network management process. When the update instruction has occurred, the process proceeds to step S2; otherwise, the process is put in the standby state.

In step S2, the devices connected to the LAN 103 are detected. The devices here refer to the copying machines 101, 101A, 101B, 101C, and 101D. The client personal computer 102 may also be included as one of the devices. The devices are detected by performing communications using the SNMP protocol. Using the SNMP protocol, a MIB request is broadcast to the devices connected to the LAN 103. Upon receiving the MIB request, each device connected to the LAN 103 sends its own MIB to the management device 100. Based on the received MIB, the management device 100 can determine whether or not the device that sent the MIB is a device to be managed. The IP address of the device that sent the MIB can also be acquired by receiving the MIB.

In the next step S3, the Web page stored on the fixed storage device 114 is updated using the IP address or the domain name indicating the IP address of the device that has been determined to be a managed device. By updating the Web page, a link to the UIRL of the device to be managed is carried on the Web page stored on the fixed storage device 114. The Web page is written in HTML (HyperText Markup Language) and, in this HTML file, the link to the URL of the device to be managed is added. In this way, the link to the copying machine to be managed is created in the management device 100.

Next, it is determined whether the device included as a managed device in step S3 has a Web server function and Web page (hereinafter simply described as whether the device has a Web page) (step S4). When the device has a Web page, the process proceeds to step S5; otherwise, the process proceeds to step S8.

Whether the device has a Web page or not is determined by sending an HTTP request message to the device by using the HTTP protocol. When the destination device of the HTTP request message has responded by sending the Web page stored in that device, and the Web page has been received successfully, then it is determined that the device has a Web page. Otherwise, it is determined that the device does not have a Web page.

In step S5, link information for linking to the management device is transmitted to the device that has been determined to have a Web page. The link information here refers to the IP address of the management device 100. The URL of the Web page stored on the fixed storage device 114 may be transmitted instead of the IP address.

If the link information for linking to the management device 100 is received at the copying machine, the link can or cannot be created at the copying machine side, depending on the case. This is determined by whether or not the software installed on the copying machine has a link creating function. If the link can be created at the copying machine side, a signal notifying that the link has been created is transmitted to the management device 100, but if the link cannot be created, nothing is transmitted.

Since the copying machine having a link creating function is a Web server, the received link information for linking to the management device 100 is written to the Web page stored in that copying machine. The Web page stored in the copying machine is written, for example, in the HTML language, and the link to the URL of the management device 100 is added in this HTML file. In this way, the link to the management device 100 is set on the Web page of the copying machine. The copying machine that received the link information creates the link to the management device 100 if the link can be created, and transmits to the management device 100 a signal notifying that the link has been created.

In step S6, based on whether or not the link creation notifying signal has been received from the copying machine, the management device 100 determines whether the copying machine can receive the link information. If the link creation notifying signal is received, it is determined that the copying machine can receive the link information, and the process proceeds to step S7; on the other hand, if the link creation notifying signal is not received, it is determined that the copying machine cannot receive the link information, and the process proceeds to step S8.

In step S7, information indicating that the link to the management device 100 has been created at the copying machine side is registered. More specifically, the Web page stored on the fixed storage device 114 is updated so that an indication indicating the existence of a cross link to the copying machine will be displayed alongside the URL of the copying machine that has transmitted the link creation notifying signal.

In the next step S8, it is determined whether there is any other copying machine that has been registered as a managed device in step S3. If there is such a copying machine, the process returns to step S4 to repeat the above processing. If there is no such copying machine, the process proceeds to step S9.

The above processing is performed on all the copying machines. In this way, of the copying machines registered as managed devices, the link information for linking to the management device is transmitted to every copying machine that has been determined to have a Web page. When the link to the management device can be created at the copying machine side, a symbol indicating the existence of a cross link to that copying machine is added at a specified position on the Web page stored on the fixed storage device 114.

In the next step S9, the Web page stored on the fixed storage device 114 is displayed on the display 119.

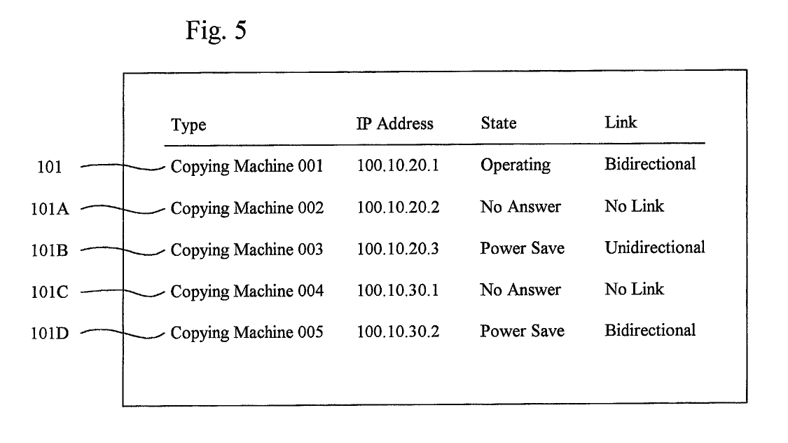

FIG. 5 is a diagram showing one example of the Web page stored in the management device 100 of the present embodiment. As shown in FIG. 5, the types, IP addresses, states, and link status of the copying machines managed by the management device 100 are shown in the form of a list on the Web page.

In FIG. 5, the type of the copying machine 101 is shown as “Copying Machine 001”, the IP address as “100.10.20.1”, the state as “Operating”, and the link status as “Bidirectional”. This means that a cross link is provided between the copying machine 101 and the management device 100, and that the copying machine 101 is currently in an operating state.

For the copying machines 110A and 101C, on the other hand, the link state is shown as “No Link”, meaning that neither the copying machine 110A nor the copying machine 101C is linked from the management device 100, nor is a link to the management device 100 provided from the copying machine 110A or the copying machine 101C.

For the copying machine 101B, the link status is shown as “Unidirectional”, meaning that only a unidirectional link is provided from the management device 100 to the copying machine 101B. No link is provided from the copying machine 101B to the management device 100.

For the copying machine 101D, the link status is shown as “Bidirectional”, meaning that a bidirectional link is provided between the copying machine 101D and the management device 100.

At the personal computer 102 as a client that browses the Web page stored in the management device 100, it is possible to know the states and IP addresses of the copying machines managed by the management device 100. Therefore, the personal computer as its client can easily change the destination of its output to any one of the currently operating copying machines.

Here, at the personal computer 102 as a client that browses the Web page stored in the management device 100, when the type “Copying Machine 001” of the bidirectionally linked copying machine 101, for example, is clicked with a mouse or the like, the URL of the Web page stored on the fixed storage device 139 in the copying machine 101 is read out, and the user can thus browse the Web page specified by that URL.

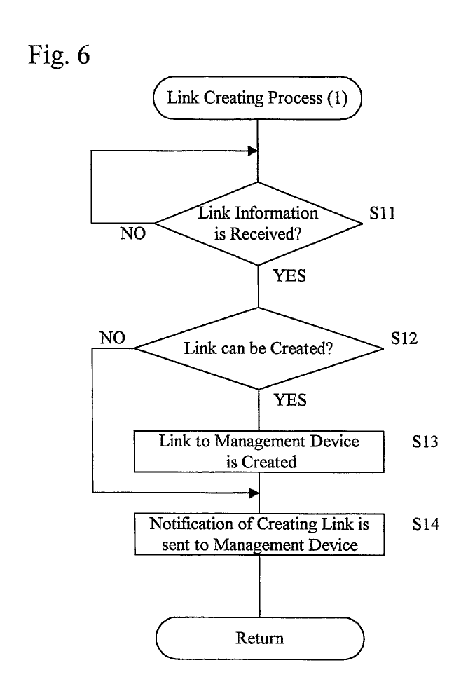

FIG. 6 is a flow chart showing the flow of the link creating process (1) performed in the copying machine 101 of the present embodiment. This process may be performed using the Web server program or using a dedicated program. In FIG. 6, the copying machine 101 determines whether link information is received from the management device 100 (step S11). When link information is received, the process proceeds to step S12; otherwise, the process is put in the standby state. Here, rather than putting the link creating process (1) in the standby state, provisions may be made to cause an interrupt when link information is received and to execute the following process.

In the next step S12, it is determined, based on the received link information, whether a link to the management device can be created or not (step S12). If the link can be created, the process proceeds to step S13; otherwise, the process proceeds to step S14. The link can be created when the copying machine 101 is a Web server. When the copying machine 101 is a Web server and has a Web page stored on its fixed storage device 139, it is determined that the link can be created; otherwise, it is determined that the link cannot be created.

In step S13, the link to the management device 100 is created. The creation of the link is accomplished by adding the link information, received from the management device 100, in the Web page stored on the fixed storage device 139. The Web page is an HTML file written in HTML format. To create the link, a tag for linking to the URL specified by the IP address of the management device 100 is written in this HTML file.

Then, in step S14, a notification indicating the creation of the link to the management device is sent to the management device 100. The management device 100 can thus detect that a cross link has been created at the copying machine to which the link information was transmitted.

Accordingly, when the copying machine 101 is operating as a Web server, the Web page of the management device 100 can be easily accessed from the client personal computer 102 by browsing the Web page of the copying machine 101, because the link to the management device 100 is provided. As a result, the user of the client personal computer can browse the Web page of the management device 100 without having to know the IP address of the management device 100, and can thus acquire the IP addresses and states of all the copying machines managed by the management device 100.

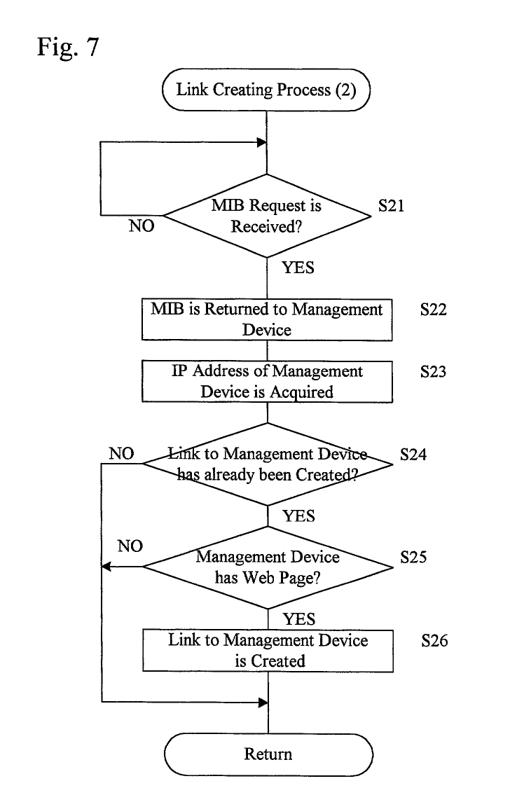

Next, a modified example of the link creating process will be described. FIG. 7 is a flow chart showing the flow of the modified link creating process performed in the copying machine 101 of the present embodiment. In the link creating process shown in FIG. 6, the copying machine created the link by receiving link information from the management device 100, but in the modified example shown in FIG. 7, the copying machine creates the link on its own initiative. In the modified link creating process (2) of FIG. 7, first it is determined whether a MIB request, using the SNMP protocol, is received from the management device 100 (step S21). When a MIB request is received, the process proceeds to step S22; otherwise, the process is put in the standby state. Here, rather than putting the process in the standby state, provisions may be made to cause an interrupt when a MIB request is received and to execute the following process. When the MIB request is received, the IP address of the management device 100 that sent the MIB is also received.

In step S22, the requested MIB is returned to the management device 100.

In the next step S23, the IP address of the management device 100, received together with the MIB request, is acquired. Then, based on the thus acquired IP address of the management device 100, it is determined whether a link to the management device 100 has already been created or not (step S24). If the link has already been created, the process is terminated; otherwise, the process proceeds to step S25. Whether the link has already been created or not is determined by checking whether a description for linking to the URL having the IP address of the management device 100 is included in the Web page stored on the fixed storage device 139 in the copying machine 101. If the description for linking to the URL having the IP address of the management device 100 is included in the Web page, it is determined that the link has already been created, but if the IP address is not included, it is determined that the link has not been created yet.

Next, it is determined whether the management device 100 has a Web page. If it is determined that the management device 100 has a Web page, the process proceeds to step S26; otherwise, the process is terminated. To check whether the management device 100 has a Web page or not, an HTTP request message is sent to the management device 100 by using the HTTP protocol. In the HTTP request message, the IP address of the management device 100 is specified as the URL. If the management device 100 responds by transmitting a Web page, it is determined that the management device 100 has a Web page, but if a Web page is not received within a predetermined time interval, it is determined that the management device 100 does not have a Web page.

In step S26, a link to the management device 100 is created. The creation of the link to the management device 100 is accomplished by adding the URL having the IP address of the management device 100 in the Web page stored on the fixed storage device 139 in the copying machine 101.

In this way, the copying machine 101 can automatically create a link to the management device 100 even when the management device 100 does not have the capability to process the steps S4 to S7 in the network management process of FIG. 4 but only has the capability to request MIBs from the managed copying machines by using the SNMP protocol.

Accordingly, when the copying machine 101 is operating as a Web server, the Web page of the management device 100 can be easily accessed from the client personal computer by just browsing the Web page of the copying machine 101. As a result, the user of the client personal computer can browse the Web page of the management device 100 without having to know the IP address of the management device 100, and can thus acquire the IP addresses and states of all the copying machines managed by the management device 100.

As described above, according to the management device of the present embodiment, since link information is transmitted to every copying machine that has been determined to be able to create a link, the copying machine connected to the LAN 103 can be linked to the management device 100.

Further, the IP address of the copying machine detected as being connected to the network is detected and stored on the fixed storage device 139. Accordingly, the link to the copying machine connected to the network can be easily created.

Since the link status of every copying machine managed by the management device 100 is shown on the Web page stored on the fixed storage device 114 in the management device 100, copying machines bidirectionally linked with the management device 100, copying machines unidirectionally linked from the management device 100, and copying machines not linked in either direction can be shown in an easily distinguishable manner. As a result, the person who is browsing the Web page can easily know the status of the link between the management device 100 and each copying machine.

The above embodiment has been described for the device management system, but it will be appreciated that the present invention can also be implemented in a program for causing a computer to carry out the processing shown in FIGS. 4, 6, and 7, or in a method for causing a computer to carry out the processing shown in FIGS. 4, 6, and 7.

The embodiment disclosed herein is to be considered in all respects as illustrative and not restrictive. The scope of the invention is defined by the appended claims rather than by the foregoing description, and all changes which come within the meaning and the range of equivalency of the claims are therefore intended to be embraced therein.

What is claimed is:

1. A management device for managing a device through a network, comprising:
a detecting portion for detecting an existence of the device connected to the network;
a determining portion for determining whether the detected device is capable of creating a link; and
a transmitting portion for transmitting to the detected device link information for linking to the management device when the detected device is determined to be capable of creating a link.

2. The management device as claimed in claim 1,
wherein the determining portion detects link information for the detected device, and the management device further includes a storing portion for storing the detected link information.

3. The management device as claimed in claim 1,
further comprising a receiving portion for receiving a notification notifying that a link has been created from the detected device.

4. The management device as claimed in claim 3,
further comprising a display device for displaying, upon receiving the notification from the detected device, information indicating that the link has been created at the detected device.

5. The management device as claimed in claim 4,
further comprising a creating portion for creating a Web page showing that a link to the management device is created at the detected device.

6. The management device as claimed in claim 2,
wherein the link information includes a network address of the detected device.

7. The management device as claimed in claim 1,
wherein the management device is a server computer.

8. A network management program which is executed on a management device that manages a device connected to a network, and which causes the management device to carry out the steps of:
detecting a existence of the device connected to the network;
determining whether the detected device is capable of creating a link;
transmitting to the detected device link information for linking to the management device when the detected device is determined to be capable of creating a link.

9. A computer readable recording medium on which the network management program described in claim 8 is recorded.

10. A managed device comprising:
a receiving portion for receiving, from a management device through a network, link information for linking to the management device; and
link creating portion for creating a link to the management device based on the received link information.

11. The managed device as claimed in claim 10, further comprising a notifying portion for notifying the management device of creation of the link when the link to the management device is created.

12. The managed device as claimed in claim 10,
further comprising a determining portion for determining whether the management device is capable of creating a link to the managed device, and wherein
when it is determined by the determining portion that the management device is capable of creating a link, the link creating portion creates the link to the management device.

13. The managed device as claimed in claim 8,
wherein the managed device is an image forming apparatus.

14. A link creating program which is executed on a managed device managed by a management device connected to a network, and which causes the managed device to carry out the steps of:
receiving, from the management device, link information for linking to the management device; and
creating a link to the management device based on the received link information.

15. A computer readable recording medium having recorded thereon the link creating program described in claim 14.

16. A managed device managed by a management device connected to a network, comprising:
an acquiring portion for acquiring a network address of the management device from the management device;
a detecting portion for detecting whether the management device is capable of creating a link to the managed device; and
a link creating portion for creating a link to the management device based on the acquired network address when it is detected by the detecting portion that the management device is capable of creating a link to the managed device.

17. A link creating program which is executed on a managed device managed by a management device connected to a network, and which causes the managed device to carry out the steps of:
acquiring a network address of the management device from the management device;
detecting whether the management device is capable of creating a link to the managed device; and
creating a link to the management device based on the acquired network address when it is detected that the management device is capable of creating a link to the managed device.

18. A computer readable recording medium on which the link creating program described in claim 17 is recorded.

19. A network management method in a management device for managing a device connected to a network, and the method comprising steps of:
detecting a existence of the device connected to the network;
determining whether the detected device is capable of creating a link;
transmitting to the detected device link information for linking to the management device when the detected device is determined to be capable of creating a link.

20. A link creating method in a managed device managed by a management device connected to a network, and the method comprising steps of:
receiving, from the management device, link information for linking to the management device; and
creating a link to the management device based on the received link information.

21. A link creating method in a managed device managed by a management device connected to a network, and the method comprising steps of:
acquiring a network address of the management device from the management device;
detecting whether the management device is capable of creating a link to the managed device; and
creating a link to the management device based on the acquired network address when it is detected that the management device is capable of creating a link to the managed device.
